(19) United States
(12) Patent Application Publication
(10) Pub. No.: US 2026/0269946 A1
(43) Pub. Date: Sep. 10, 2026

(54) COMMUNICATION CIRCUIT, SEMICONDUCTOR DEVICE, AND ELECTRONIC APPARATUS

(71) Applicant: SANKEN ELECTRIC CO., LTD., Niiza-Shi (JP)

(72) Inventor: Takanaga YAMAZAKI, Niiza-Shi (JP)

(73) Assignee: SANKEN ELECTRIC CO., LTD., Niiza-Shi (JP)

(21) Appl. No.: 19/551,688

(22) Filed: Feb. 27, 2026

(30) Foreign Application Priority Data
Mar. 7, 2025 (JP) 2025-036485

(51) Int. Cl. H04B 10/40; H04B 10/50

(52) U.S. Cl. CPC H04B 10/40; H04B 10/502

(57) ABSTRACT

A communication circuit according to one or more embodiments is disclosed that transmits and receives an optical signal to and from another device. The communication circuit may include a processor, an LED, and first to fourth switches may be controllable by the processor. The first switch may be on or off when the LED emits the optical signal, and off when the LED receives the optical signal. The second switch may be on when the LED emits the optical signal, and off when the LED receives the optical signal. The third switch may be off when the LED emits the optical signal, and on when the LED receives the optical signal. The fourth switch may be off when the LED emits the optical signal, and on when the LED receives the optical signal.

### CROSS-REFERENCE TO RELATED APPLICATIONS

The present application claims priority from Japanese Patent Application No. 2025-036485 filed on March 7, 2025, the entire contents of which are hereby incorporated by reference.

### TECHNICAL FIELD

The disclosure relates to a communication circuit, a semiconductor device, and an electronic apparatus.

### BACKGROUND ART

A technique enabling bidirectional isolated communication in an integrated circuit (IC) package has been proposed. For example, Chinese Patent Application Publication No. 115001585 (CN115001585A) discloses an integrated transmission-reception communication circuit that achieves a one-wire half-duplex communication mode in an electrically isolated state. The integrated transmission-reception communication circuit disclosed in CN115001585A enables half-duplex serial transmission with a light-emitting element or a light-emitting edge provided on a transmission side and a light-receiving element or a transmission-identifying element provided on a reception side.

### SUMMARY

A communication circuit according to one or more embodiments may be configured to transmit and receive an optical signal to and from another device through an optical signal propagator. The communication circuit may include a processor, a light-emitting diode, a first switch, a second switch, a third switch, and a fourth switch. The processor may be configured to control emission and reception of the optical signal. The light-emitting diode may have a cathode side coupled to a first terminal and an anode side coupled to a second terminal, and may be configured to emit and receive the optical signal. The first switch may be provided between the first terminal and a ground. The first switch may be configured to be controlled, through control from the processor, to be on or off when the light-emitting diode emits the optical signal, and to be off when the light-emitting diode receives the optical signal. The second switch may be provided between the second terminal and a power supply. The second switch may be configured to be controlled, through control from the processor, to be on when the light-emitting diode emits the optical signal, and to be off when the light-emitting diode receives the optical signal. The third switch may be provided between the second terminal and the ground. The third switch may be configured to be controlled, through control from the processor, to be off when the light-emitting diode emits the optical signal, and to be on when the light-emitting diode receives the optical signal. The fourth switch may be provided between the first terminal and the power supply. The fourth switch is configured to be controlled, through control from the processor, to be off when the light-emitting diode emits the optical signal, and to be on when the light-emitting diode receives the optical signal.

A semiconductor device according to one or more embodiments may include a first communication circuit, a second communication circuit, and an optical signal propagator. Each of the first communication circuit and the second communication circuit may be a communication circuit configured to transmit and receive an optical signal to and from another device through the optical signal propagator, and including a processor, a light-emitting diode, a first switch, a second switch, a third switch, and a fourth switch. The processor may be configured to control emission and reception of the optical signal. The light-emitting diode may have a cathode side coupled to a first terminal and an anode side coupled to a second terminal, and may be configured to emit and receive the optical signal. The first switch may be provided between the first terminal and a ground. The first switch is configured to be controlled, through control from the processor, to be on or off when the light-emitting diode emits the optical signal, and to be off when the light-emitting diode receives the optical signal. The second switch may be provided between the second terminal and a power supply. The second switch may be configured to be controlled, through control from the processor, to be on when the light-emitting diode emits the optical signal, and to be off when the light-emitting diode receives the optical signal. The third switch may be provided between the second terminal and the ground. The third switch may be configured to be controlled, through control from the processor, to be off when the light-emitting diode emits the optical signal, and to be on when the light-emitting diode receives the optical signal. The fourth switch may be provided between the first terminal and the power supply. The fourth switch may be configured to be controlled, through control from the processor, to be off when the light-emitting diode emits the optical signal, and to be on when the light-emitting diode receives the optical signal. The first communication circuit may be coupled to a first host. The second communication circuit may be coupled to a second host. The optical signal propagator may be provided between a first light-emitting diode and a second light-emitting diode. The first light-emitting diode may be the light-emitting diode of the first communication circuit. The second light-emitting diode may be the light-emitting diode of the second communication circuit.

An electronic apparatus according to one or more embodiments may include a semiconductor device, a first host, and a second host. The semiconductor device may include a first communication circuit, a second communication circuit, and an optical signal propagator. Each of the first communication circuit and the second communication circuit may be a communication circuit configured to transmit and receive an optical signal to and from another device through the optical signal propagator, and including a processor, a light-emitting diode, a first switch, a second switch, a third switch, and a fourth switch. The processor may be configured to control emission and reception of the optical signal. The light-emitting diode may have a cathode side coupled to a first terminal and an anode side coupled to a second terminal, and is configured to emit and receive the optical signal. The first switch may be provided between the first terminal and a ground. The first switch may be configured to be controlled, through control from the processor, to be on or off when the light-emitting diode emits the optical signal, and to be off when the light-emitting diode receives the optical signal. The second switch may be provided between the second terminal and a power supply. The second switch may be configured to be controlled, through control from the processor, to be on when the light-emitting diode emits the optical signal, and to be off when the light-emitting diode receives the optical signal. The third switch may be provided between the second terminal and the ground. The third switch may be configured to be controlled, through control from the processor, to be off when the light-emitting diode emits the optical signal, and to be on when the light-emitting diode receives the optical signal. The fourth switch may be provided between the first terminal and the power supply. The fourth switch may be configured to be controlled, through control from the processor, to be off when the light-emitting diode emits the optical signal, and to be on when the light-emitting diode receives the optical signal. The first communication circuit may be coupled to the first host. The second communication circuit is coupled to the second host. The optical signal propagator may be provided between a first light-emitting diode and a second light-emitting diode. The first light-emitting diode may be the light-emitting diode of the first communication circuit. The second light-emitting diode may be the light-emitting diode of the second communication circuit. Each of the first communication circuit and the second communication circuit may include a buffer. The buffer may be configured to buffer data transmitted from corresponding one of the first and second hosts and data to be received by the corresponding one of the first and second hosts. A communication speed between the first light-emitting diode and the second light-emitting diode may be higher than a communication speed between the first host and the first communication circuit and a communication speed between the second host and the second communication circuit.

### BRIEF DESCRIPTION OF THE DRAWINGS

The accompanying drawings are included to provide a further understanding of the disclosure, and are incorporated in and constitute a part of this specification. The drawings illustrate an embodiment or embodiments and, together with the specification, serve to explain the principles of the disclosure.

FIG. 1 is a block diagram illustrating a configuration of a semiconductor device and an electronic apparatus according to one or more embodiments.

FIG. 2 is a cross-sectional diagram illustrating a configuration of the semiconductor device according to one or more embodiments.

FIG. 3 is a block diagram illustrating a configuration of the semiconductor device according to one or more embodiments.

FIG. 4 is a diagram illustrating a configuration of a processor according to one or more embodiments.

FIG. 5 is a chart for describing a characteristic of a photodiode.

FIG. 6 is a table for describing control to be performed at times of emission and reception of optical signals in the communication circuit according to one or more embodiments.

FIG. 7 is a chart for describing communications to be performed by the semiconductor device according to one or more embodiments.

FIG. 8 is a chart for describing communications to be performed by the semiconductor device according to one or more embodiments.

### DETAILED DESCRIPTION

Bidirectional isolated communication using the integrated transmission-reception communication circuit disclosed in CN115001585A involves a total of four photo devices, i.e., two sets of light-emitting elements and light-receiving elements. A technique is thus demanded that makes it possible to provide a bidirectional isolated communication circuit in an integrated circuit (IC) package with a simpler configuration.

It may be desirable to provide a communication circuit, a semiconductor device, and an electronic apparatus that each enables bidirectional isolated communication in an IC package with a simple configuration.

A semiconductor device, a communication circuit, and an electronic apparatus according to one or more embodiments are described in detail below with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### Outline of Semiconductor Device 1

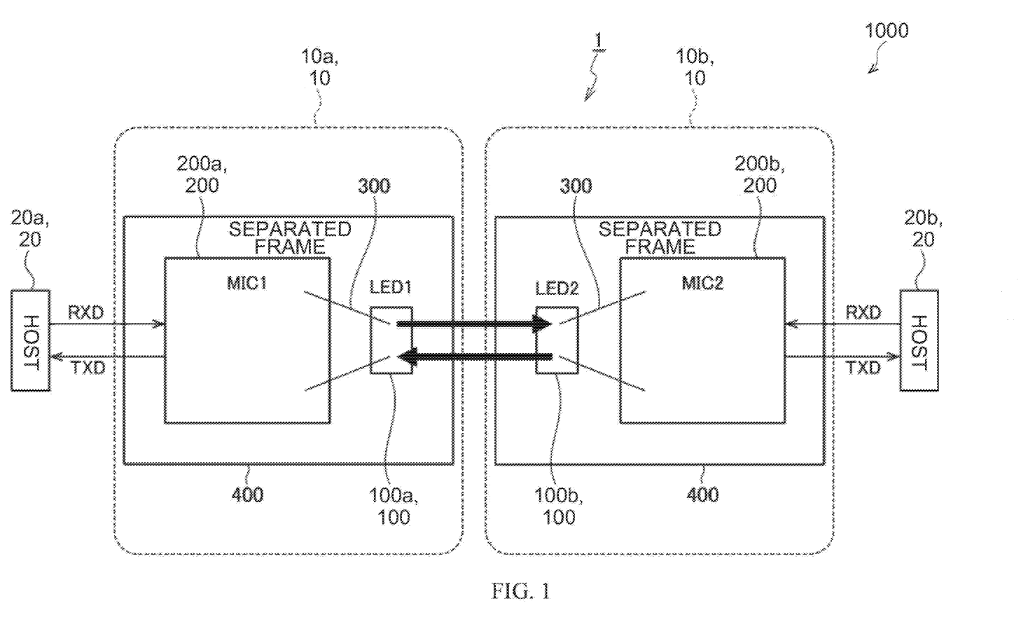

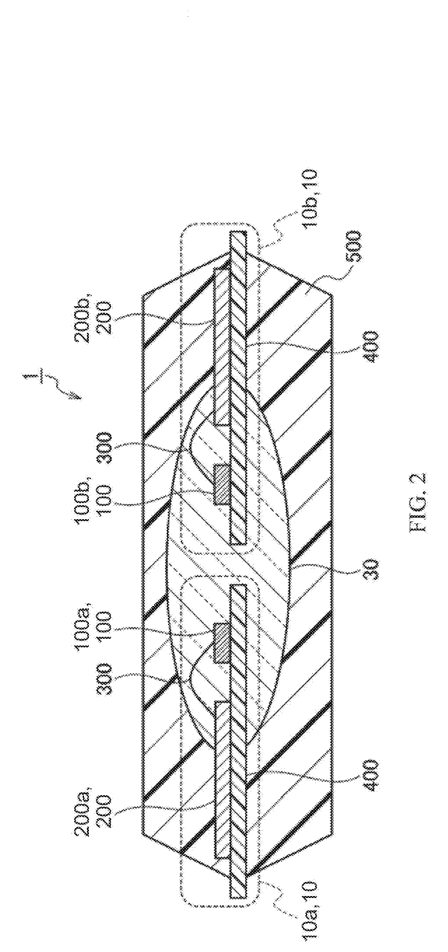

FIG. 1 is a block diagram illustrating a configuration of the semiconductor device 1 and the electronic apparatus 1000 according to an example embodiment. FIG. 2 is a cross-sectional diagram illustrating a configuration of the semiconductor device 1 according to the example embodiment. The semiconductor device 1 may be a device that enables bidirectional isolated communication in an IC package. An example illustrated in FIG. 1 may provide bidirectional communication between a first host 20a and a second host 20b, for example. In the example illustrated in FIG. 1, the electronic apparatus 1000 may include the semiconductor device 1, the first host 20a, and the second host 20b, for example.

Typical techniques used in performing bidirectional isolated communication may include, for example, (a) a technique based on optical coupling using a photocoupler, (b) a technique based on electromagnetic coupling, and (c) a technique based on capacitive coupling. Among these techniques, each of (b) and (c), that is, galvanic isolation, gives rise to complexity in circuit scheme and mechanical structure, resulting in increased cost for placement of circuitry within an IC package. Further, each of (b) and (c) involves a configuration in which electromagnetic coupling is established, which makes it difficult to achieve a sufficient increase in dielectric strength.

In contrast, (a), the technique based on optical coupling, allows for a simple circuit and ease of increasing dielectric strength, compared to (b) and (c) above. On the other hand, bidirectional isolated communication through the use of the technique (a) involves a total of four photo devices, i.e., two sets of light-emitting elements and light-receiving elements.

To provide a bidirectional isolated communication circuit in an IC package, the semiconductor device 1 according to one or more embodiments uses a light-emitting diode (LED) 100 in bidirectional communication. For example, each single LED 100 serves to emit and receive optical signals.

Two sets of LEDs 100 and processors 200 may be placed on respective separate lead frames 400. To secure an optical propagation space between the LEDs 100 in the semiconductor device 1, the optical propagation space may be protected with a transparent, heat-resistant silicone resin. Bidirectional communication between the LEDs 100 may be performed in a half-duplex mode. Further, an apparent full-duplex mode may be achieved for communications to and from the first host 20a and the second host 20b.

A detailed description is given below of the configuration of the semiconductor device 1 according to the example embodiment.

### Configuration of Semiconductor Device 1

As illustrated in FIG. 2, the semiconductor device 1 includes two communication circuits 10 each including the LED 100 and the processor 200. The LED 100 and the processor 200 may be placed on the lead frame 400. The communication circuits 10 may each perform half-duplex communication through an optical signal propagator 30. The optical signal propagator 30 may include, for example, a transparent, heat-resistant silicone resin. The semiconductor device 1 may be covered with a semiconductor sealing member 500 that resin-seals the LEDs 100, the processors 200, and the lead frames 400. Note that the lead frame 400 applicable to the semiconductor device 1 according to one or more embodiments may include a typical substrate.

The LED 100 applicable to each of the communication circuits 10 according to one or more embodiments may include, for example, a red LED. However, this is not to be construed as limiting a configuration according to one or more embodiments. In one or more embodiments, considering ease of availability or cost, the LED 100 may include a non-red LED.

As described above, bidirectional communication between the first host 20a and the second host 20b is achievable in the example illustrated in FIG. 1. As illustrated in FIG. 1, the semiconductor device 1 may include a first communication circuit 10a and a second communication circuit 10b. The first communication circuit 10a may include a first LED 100a and a first processor 200a. The first LED 100a and the first processor 200a may be coupled to each other via a wiring line 300.

Similarly, the second communication circuit 10b may include a second LED 100b and a second processor 200b. The second LED 100b and the second processor 200b may be coupled to each other via a wiring line 300. In the example illustrated in FIG. 1, the first processor 200a and the second processor 200b are denoted as "MIC1" and "MIC2", respectively, where MIC represents a monolithic IC.

Hereinafter, the first communication circuit 10a and the second communication circuit 10b will each be simply referred to as the "communication circuit 10" when it is not necessary to distinguish the two communication circuits 10a and 10b from each other. Further, the first LED 100a and the second LED 100b will each be simply referred to as the "LED 100" when it is not necessary to distinguish the two LEDs 100a and 100b from each other. Similarly, the first processor 200a and the second processor 200b will each be simply referred to as the "processor 200" when it is not necessary to distinguish the two processors 200a and 200b from each other. Further, the first host 20a and the second host 20b will each be simply referred to as the "host 20" when it is not necessary to distinguish the two hosts 20a and 20b from each other.

In the configuration illustrated in FIG. 1, based on reception data RXD received by the first communication circuit 10a from the first host 20a, the first communication circuit 10a may transmit a signal to the second communication circuit 10b through the first LED 100a. The second communication circuit 10b may receive, through the second LED 100b, the signal transmitted from the first communication circuit 10a, and may transmit transmission data TXD to the second host 20b.

Similarly, based on reception data RXD received by the second communication circuit 10b from the second host 20b, the second communication circuit 10b may transmit a signal to the first communication circuit 10a through the second LED 100b. The first communication circuit 10a may receive, through the first LED 100a, the signal transmitted from the second communication circuit 10b, and may transmit transmission data TXD to the first host 20a. The semiconductor device 1 may thereby achieve bidirectional communication through the LEDs 100. The bidirectional communication between the first LED 100a and the second LED 100b may be performed in the half-duplex mode.

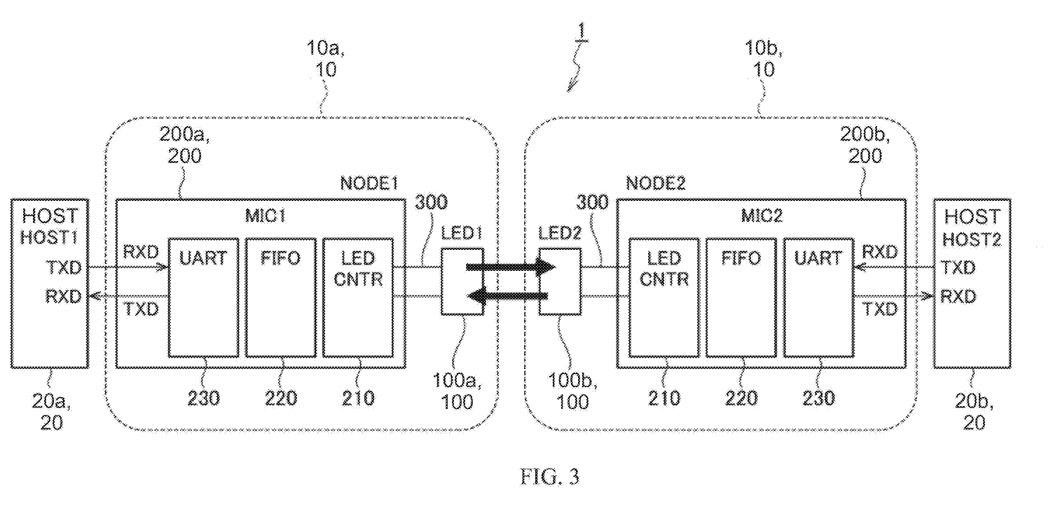

FIG. 3 is a block diagram illustrating a configuration of the processor 200 of the semiconductor device 1 according to the example embodiment. As illustrated in FIG. 3, the processor 200 may include an LED control circuit 210, a buffer 220, and an input and output interface (IF) 230.

The LED control circuit 210 may be a controller that controls emission and reception of optical signals by the LED 100. In other words, the LED 100 may be controlled by the LED control circuit 210 to emit and receive optical signals. Details of the control to be performed on the LED 100 by the LED control circuit 210 will be described later.

The buffer 220 may temporarily hold, i.e., buffer, data to be exchanged between the host 20 and the LED 100. The buffer 220 may include a First-In, First-Out (FIFO) buffer. The use of the buffer 220 helps to achieve the apparent full-duplex mode for communications between the first host 20a and the second host 20b.

The input and output IF 230 may be an interface enabling communication with the host 20. For example, as illustrated in FIG. 3, the input and output IF 230 may include a universal asynchronous receiver-transmitter (UART). However, the input and output IF 230 is not limited to the UART. In some embodiments, the input and output IF 230 may include another serial interface such as a serial peripheral interface (SPI) or an inter-integrated circuit (I²C).

An example of communication between the hosts 20 will now be described with reference to FIG. 3. In the semiconductor device 1 according to the example embodiment, an LED packet communication from the first communication circuit 10a to the second communication circuit 10b and an LED packet communication from the second communication circuit 10b to the first communication circuit 10a may be alternately performed.

First, the LED packet communication from the first communication circuit 10a to the second communication circuit 10b may be started. Note that the alternate LED packet communications may be performed even in the absence of communications from the hosts 20.

An LED packet may include a start code, a body data length, body data itself, and an end code. In some embodiments, the LED packet may further include a cyclic redundancy check (CRC) code.

When each of the communication circuits 10 receives data from corresponding one of the hosts 20, corresponding one of the processors 200 may load the received data on the LED packet as the body data. When no data is received, a short LED packet with no body data may result. Upon receiving an LED packet with body data, each of the communication circuits 10 may transmit the data to the corresponding one of the hosts 20.

To prevent excessively long LED packets from being communicated alternately, the body data may be divided at regular intervals. Although communications between the LEDs 100 may be performed in the half-duplex mode, communications between the hosts 20 may be performed in the apparent full-duplex mode, owing to buffering (e.g., smoothing out of speed discrepancies) performed by the buffer 220.

A communication speed between the first LED 100a of the first communication circuit 10a and the second LED 100b of the second communication circuit 10b may be higher than a communication speed between the first host 20a and the first communication circuit 10a and a communication speed between the second host 20b and the second communication circuit 10b.

For example, the communication speed between the first LED 100a and the second LED 100b may be from about two times to about four times higher than the communication speed between the first host 20a and the first communication circuit 10a and the communication speed between the second host 20b and the second communication circuit 10b. For example, when the input and output IF 230 includes the UART and the communication speed, or baud rate, between the communication circuit 10 and the host 20 is 115200 bps, the communication speed between the LEDs 100 may be 400 kbps. This helps to allow the semiconductor device 1 to achieve full-duplex communication between the hosts 20 with higher reliability.

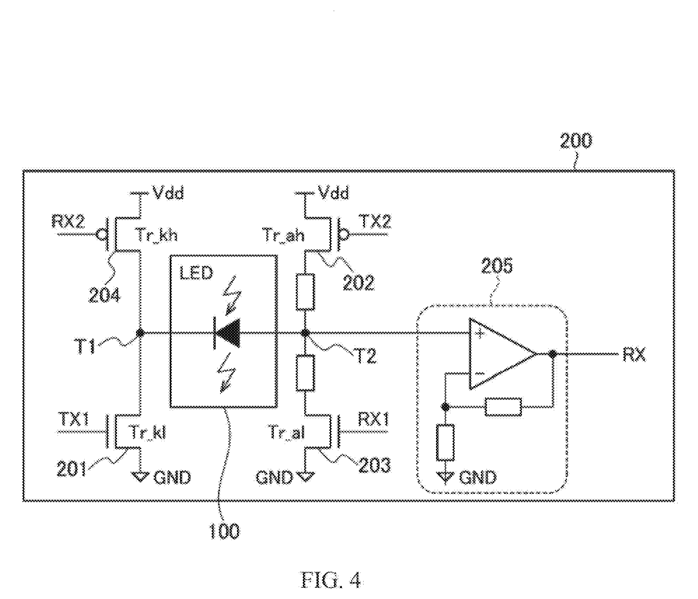

Reference is now made to FIG. 4 to describe details of control to be performed on the LED 100. FIG. 4 illustrates a configuration of the processor 200 according to the example embodiment. As illustrated in FIG. 4, the processor 200 may include a first switch 201, a second switch 202, a third switch 203, a fourth switch 204, and an amplifier 205. As illustrated in FIG. 4, the LED 100 has a cathode side coupled to a first terminal T1 and an anode side coupled to a second terminal T2.

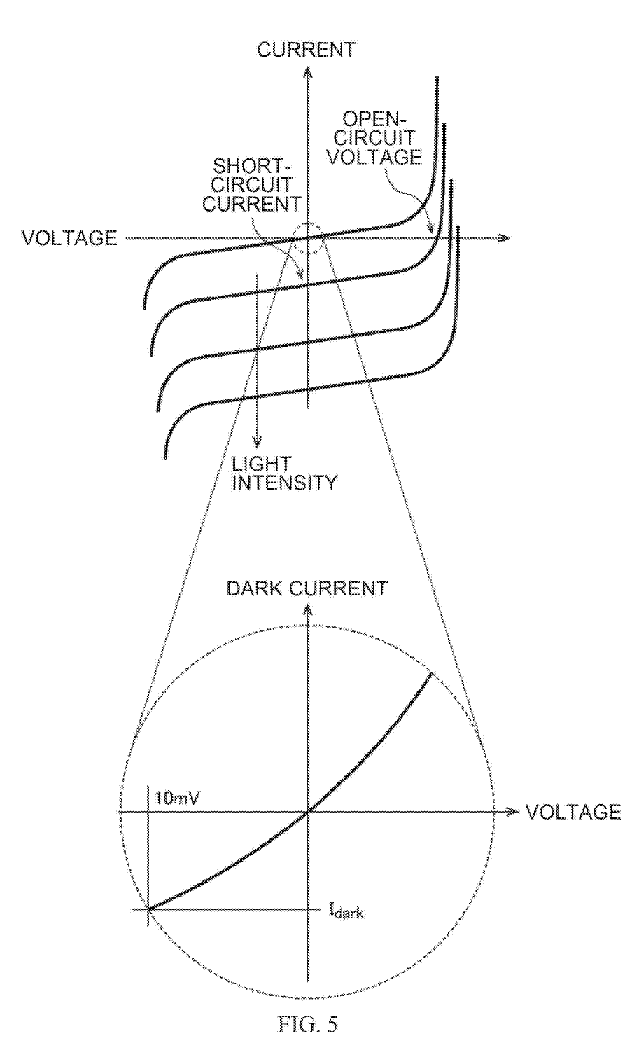

In general, an LED, even when used as a light-receiving element, has a characteristic substantially similar to that of a photodiode. A voltage-versus-current curve of the photodiode is similar to that of a normal diode, except for a difference in that the entire curve shifts upward and downward with variations in level of light. An upper part of FIG. 5 is a graph of a transfer function of the photodiode, and a lower part of FIG. 5 illustrates a dark current characteristic obtained by enlarging a part of the graph in the upper part of FIG. 5 around an origin. The enlarged graph in the lower part of FIG. 5 indicates that the photodiode outputs a small amount of current even in the absence of light. A dark current I_{dark} in the enlarged graph in the lower part of FIG. 5 increases with increasing reverse voltage applied to the photodiode.

When a sensitive part of the photodiode is exposed to light, a current flows from a cathode to an anode. In the communication circuit 10 according to the example embodiment, when receiving an optical signal, the LED 100 may be reverse-biased to use the characteristic of the photodiode that a reverse dark current increases with increasing amount of received light.

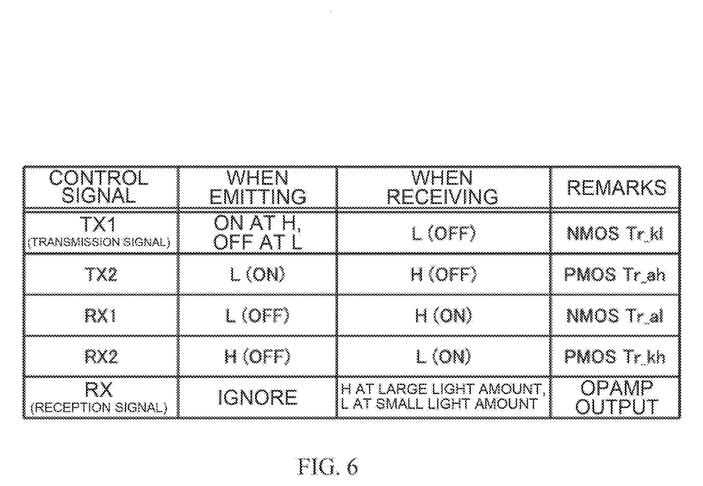

FIG. 6 is a table for describing control to be performed at times of emission and reception of optical signals in the communication circuit 10 according to the example embodiment. In an example illustrated in each of FIGS. 4 and 6, TX1, TX2, RX1, and RX2 correspond to signals at respective gate terminals of the first switch 201, the second switch 202, the third switch 203, and the fourth switch 204, respectively.

The first switch 201 is provided between the first terminal T1 and a ground GND, and is controlled, through control from the processor 200, to be on or off when the LED 100 emits an optical signal, and to be off when the LED 100 receives an optical signal.

For example, the first switch 201 may correspond to an n-channel metal-oxide-semiconductor (NMOS) transistor provided on a low side in a region closer to a cathode of the LED 100 and denoted as Tr_kl in FIGS. 4 and 6. The first switch 201 may be on when a voltage applied to the gate terminal is at a high level, and may be off when the voltage applied to the gate terminal is at a low level.

The second switch 202 is provided between the second terminal T2 and a power supply Vdd, and is controlled, through control from the processor 200, to be on when the LED 100 emits an optical signal, and to be off when the LED 100 receives an optical signal.

For example, the second switch 202 may correspond to a p-channel metal-oxide-semiconductor (PMOS) transistor provided on a high side in a region closer to an anode of the LED 100 and denoted as Tr_ah in FIGS. 4 and 6. The second switch 202 may be off when the voltage applied to the gate terminal is at the high level, and may be on when the voltage applied to the gate terminal is at the low level.

The third switch 203 is provided between the second terminal T2 and the ground GND, and is controlled, through control from the processor 200, to be off when the LED 100 emits an optical signal, and to be on when the LED 100 receives an optical signal.

For example, the third switch 203 may correspond to an NMOS transistor provided on the low side in the region closer to the anode of the LED 100 and denoted as Tr_al in FIGS. 4 and 6. The third switch 203 may be on when the voltage applied to the gate terminal is at the high level, and may be off when the voltage applied to the gate terminal is at the low level.

The fourth switch 204 is provided between the first terminal T1 and the power supply Vdd, and is controlled, through control from the processor 200, to be off when the LED 100 emits an optical signal, and to be on when the LED 100 receives an optical signal.

For example, the fourth switch 204 may correspond to a PMOS transistor provided on the high side in the region closer to the cathode of the LED 100 and denoted as Tr_kh in FIGS. 4 and 6. The fourth switch 204 may be off when the voltage applied to the gate terminal is at the high level, and may be on when the voltage applied to the gate terminal is at the low level.

The amplifier 205 may be coupled to the second terminal T2. A resistor may be provided between the second terminal T2 and the third switch 203. The resistor may convert a dark current, of the LED 100, flowing through the second terminal T2 when the LED 100 receives an optical signal into a voltage. The amplifier 205 may amplify the voltage resulting from the conversion at the resistor, and may output the amplified voltage from the processor 200 as a reception signal RX. The amplifier 205 amplifying the voltage resulting from the dark current flowing through the LED 100 helps to achieve improved accuracy in receiving the optical signal.

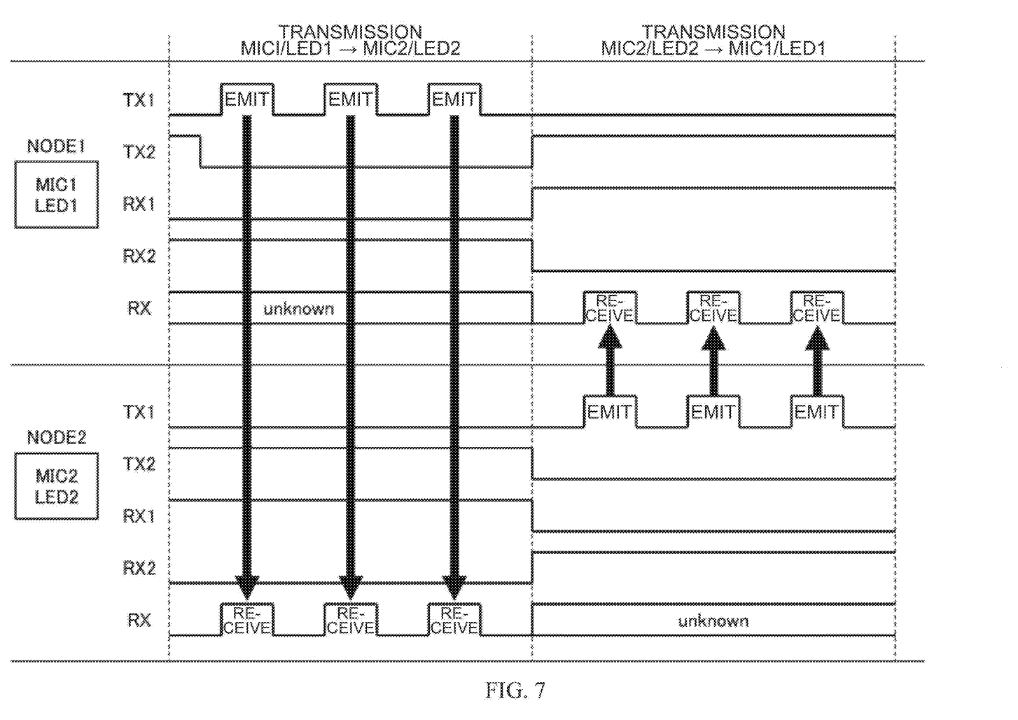

FIG. 7 is a chart for describing communications to be performed by the semiconductor device 1 according to the example embodiment, that is, communications between the first LED 100a and the second LED 100b. In FIG. 7, NODE 1 corresponds to the first communication circuit 10a, and NODE 2 corresponds to the second communication circuit 10b.

In FIG. 7, a timing chart on the left side represents a case of transmission from the first communication circuit 10a to the second communication circuit 10b, and a timing chart on the right side represents a case of transmission from the second communication circuit 10b to the first communication circuit 10a.

### Case of Transmission from First Communication Circuit 10a to Second Communication Circuit 10b

In the case of transmission from the first communication circuit 10a to the second communication circuit 10b, as illustrated in FIGS. 6 and 7, the second switch 202 of the first communication circuit 10a may be on (i.e., the signal TX2 may be low), and the third and fourth switches 203 and 204 of the first communication circuit 10a may be off (i.e., the signal RX1 may be low and the signal RX2 may be high). The first switch 201 of the first communication circuit 10a may be turned on (i.e., the signal TX1 may turn high) at timings of emission.

In contrast, as illustrated in FIGS. 6 and 7, the first and second switches 201 and 202 of the second communication circuit 10b may be off (i.e., the signal TX1 may be low and the signal TX2 may be high), and the third and fourth switches 203 and 204 of the second communication circuit 10b may be on (i.e., the signal RX1 may be high and the signal RX2 may be low). The reception signal RX, that is, an operational amplifier (OPAMP) output having undergone amplification at the amplifier 205 of the second communication circuit 10b, may turn high at timings of reception.

### Case of Transmission from Second Communication Circuit 10b to First Communication Circuit 10a

In the case of transmission from the second communication circuit 10b to the first communication circuit 10a, as illustrated in FIGS. 6 and 7, the second switch 202 of the second communication circuit 10b may be on (i.e., the signal TX2 may be low), and the third and fourth switches 203 and 204 of the second communication circuit 10b may be off (i.e., the signal RX1 may be low and the signal RX2 may be high). The first switch 201 of the second communication circuit 10b may be turned on (i.e., the signal TX1 may turn high) at timings of emission.

In contrast, as illustrated in FIGS. 6 and 7, the first and second switches 201 and 202 of the first communication circuit 10a may be off (i.e., the signal TX1 may be low and the signal TX2 may be high), and the third and fourth switches 203 and 204 of the first communication circuit 10a may be on (i.e., the signal RX1 may be high and the signal RX2 may be low). The reception signal RX, that is, an OPAMP output having undergone amplification at the amplifier 205 of the first communication circuit 10a, may turn high at timings of reception.

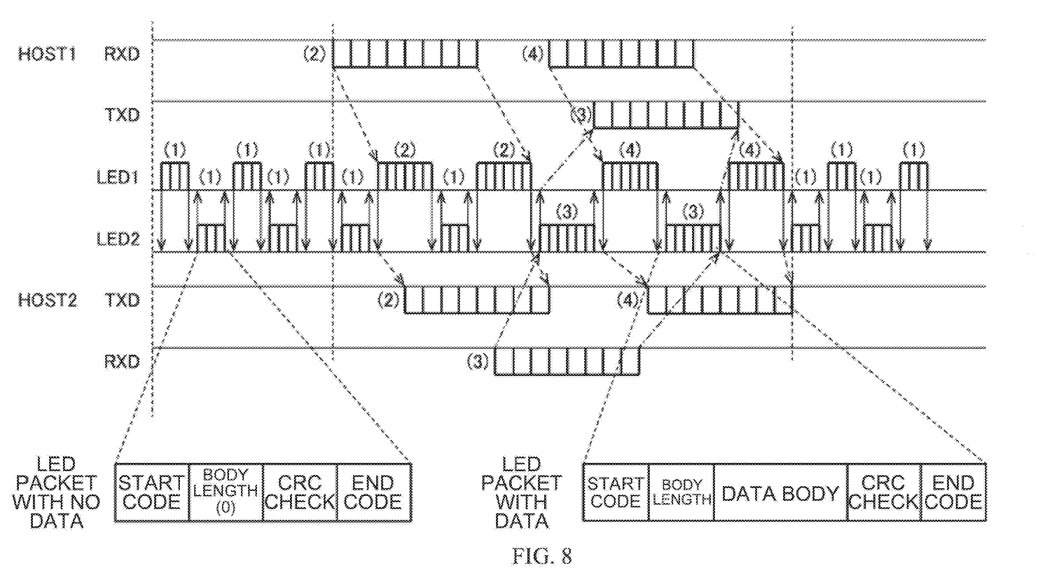

FIG. 8 is a chart for describing communications to be performed by the semiconductor device 1 according to the example embodiment, that is, communications between the hosts 20.

When no data is transmitted from the host 20, LED packets with no data may be alternately transmitted and received between the LEDs 100. See (1) of FIG. 8.

Upon receiving reception data RXD from the first host 20a, the first communication circuit 10a may divide the reception data RXD into LED packets with data and optically communicate the LED packets with data from the first LED 100a to the second LED 100b. The second communication circuit 10b may transmit transmission data TXD to the second host 20b. See (2) of FIG. 8.

The LED packets with data may be made uniform in size to prevent communication from one of the LEDs 100 to the other from continuing for a long time and to thereby enable constant mutual communications between the LEDs 100. See (2) of FIG. 8. This helps to establish apparent full-duplex communication with the hosts 20.

Upon receiving reception data RXD from the second host 20b, the second communication circuit 10b may divide the reception data RXD into LED packets with data and optically communicate the LED packets with data from the second LED 100b to the first LED 100a. The first communication circuit 10a may transmit transmission data TXD to the first host 20a. See (3) of FIG. 8.

For example, at the second host 20b in FIG. 8, the transmission data TXD ((2) of FIG. 8) and the reception data RXD ((3) of FIG. 8) may overlap each other. The apparent full-duplex communication may thus be established.

Upon receiving reception data RXD from the first host 20a, the first communication circuit 10a may divide the reception data RXD into LED packets with data and optically communicate the LED packets with data from the first LED 100a to the second LED 100b. The second communication circuit 10b may transmit transmission data TXD to the second host 20b. See part (4) of FIG. 8. For example, at the first host 20a in FIG. 8, the transmission data TXD ((3) of FIG. 8) and the reception data RXD ((4) of FIG. 8) may overlap each other. The apparent full-duplex communication may thus be established.

As described above, the communication circuit 10 transmits and receives an optical signal to and from another device through the optical signal propagator 30. The communication circuit 10 includes the processor 200 that controls emission and reception of the optical signal. The communication circuit 10 further includes the LED 100 having the cathode side coupled to the first terminal T1 and the anode side coupled to the second terminal T2. The LED 100 emits and receives the optical signal. The communication circuit 10 further includes the first switch 201 provided between the first terminal T1 and the ground GND. The first switch 201 is controlled, through control from the processor 200, to be on or off when the LED 100 emits the optical signal, and to be off when the LED 100 receives the optical signal. The communication circuit 10 further includes the second switch 202 provided between the second terminal T2 and the power supply Vdd. The second switch 202 is controlled, through control from the processor 200, to be on when the LED 100 emits the optical signal, and to be off when the LED 100 receives the optical signal. The communication circuit 10 further includes the third switch 203 provided between the second terminal T2 and the ground GND. The third switch 203 is controlled, through control from the processor 200, to be off when the LED 100 emits the optical signal, and to be on when the LED 100 receives the optical signal. The communication circuit 10 further includes the fourth switch 204 provided between the first terminal T1 and the power supply Vdd. The fourth switch 204 is controlled, through control from the processor 200, to be off when the LED 100 emits the optical signal, and to be on when the LED 100 receives the optical signal.

This makes it unnecessary to provide a light-emitting element and a light-receiving element separately from each other in the communication circuit 10, and helps to, by the provision of the single LED 100, allow the communication circuit 10 to transmit and receive optical signals to and from another communication circuit 10. That is, the communication circuit 10 helps to achieve bidirectional isolated communication in an IC package with a simple configuration.

In some embodiments, the communication circuit 10 may further include the amplifier 205 coupled to the second terminal T2. The amplifier 205 may be configured to amplify the voltage resulting from the dark current, of the LED 100, that flows through the second terminal T2 when the LED 100 receives the optical signal. The amplifier 205 amplifying the voltage resulting from the dark current flowing through the LED 100 helps to allow the communication circuit 10 to achieve improved accuracy in receiving the optical signal.

### Other Embodiments

Although some example embodiments of the disclosure have been described in detail with reference to the accompanying drawings, the disclosure is by no means limited by what is described in relation to such example embodiments above. Further, the components described hereinabove include those that may be readily conceived by a person skilled in the art and those that are substantially the same. Still further, any two or more of the configurations described hereinabove may be combined as appropriate. It is to be appreciated that various omissions, alterations, and modifications may be made to any of the configurations without departing from the gist of embodiments of the disclosure.

Features of the communication circuit 10, the semiconductor device 1, and the electronic apparatus 1000 will be described below.

In accordance with one or more embodiments, the communication circuit 10 is configured to transmit and receive an optical signal to and from another device through the optical signal propagator 30. The communication circuit 10 includes the processor 200 configured to control emission and reception of the optical signal. The communication circuit 10 further includes the LED 100 having the cathode side coupled to the first terminal T1 and the anode side coupled to the second terminal T2. The LED 100 is configured to emit and receive the optical signal. The communication circuit 10 further includes the first switch 201 provided between the first terminal T1 and the ground GND. The first switch 201 is configured to be controlled, through control from the processor 200, to be on or off when the LED 100 emits the optical signal, and to be off when the LED 100 receives the optical signal. The communication circuit 10 further includes the second switch 202 provided between the second terminal T2 and the power supply Vdd. The second switch 202 is configured to be controlled, through control from the processor 200, to be on when the LED 100 emits the optical signal, and to be off when the LED 100 receives the optical signal. The communication circuit 10 further includes the third switch 203 provided between the second terminal T2 and the ground GND. The third switch 203 is configured to be controlled, through control from the processor 200, to be off when the LED 100 emits the optical signal, and to be on when the LED 100 receives the optical signal. The communication circuit 10 further includes the fourth switch 204 provided between the first terminal T1 and the power supply Vdd. The fourth switch 204 is configured to be controlled, through control from the processor 200, to be off when the LED 100 emits the optical signal, and to be on when the LED 100 receives the optical signal.

This configuration makes it unnecessary to provide a light-emitting element and a light-receiving element separately from each other in the communication circuit 10, and helps to, by the provision of the single LED 100, allow the communication circuit 10 to transmit and receive optical signals to and from another communication circuit 10. That is, the communication circuit 10 helps to enable bidirectional isolated communication in an IC package with a simple configuration.

In according to one or more embodiments, the communication circuit 10 may further include the amplifier 205 coupled to the second terminal T2. The amplifier 205 may be configured to amplify the voltage resulting from the dark current, of the LED 100, that flows through the second terminal T2 when the LED 100 receives the optical signal.

By this configuration, the voltage resulting from the dark current flowing through the LED 100 may be amplified by the amplifier 205. This helps to allow the communication circuit 10 to achieve improved accuracy in receiving the optical signal.

In accordance with one or more embodiments, the semiconductor device 1 may include the first communication circuit 10a coupled to the first host 20a and the second communication circuit 10b coupled to the second host 20b. The first communication circuit 10a may be the communication circuit 10 described above. The second communication circuit 10b may be the communication circuit 10 described above. The semiconductor device 1 may further include the optical signal propagator 30 provided between the first LED 100a of the first communication circuit 10a and the second LED 100b of the second communication circuit 10b.

This configuration makes it unnecessary to provide a light-emitting element and a light-receiving element separately from each other in each of the communication circuits 10a and 10b included in the semiconductor device 1, and helps to, by the provision of the single LED 100 in each of the communication circuits 10a and 10b, allow the communication circuits 10a and 10b to transmit and receive optical signals to and from each other. That is, the semiconductor device 1 helps to enable bidirectional isolated communication in an IC package with a simple configuration, without necessitating a total of four photo devices, i.e., two sets of light-emitting elements and light-receiving elements.

In accordance with one or more embodiments, each of the first communication circuit 10a and the second communication circuit 10b of the semiconductor device 1 may further include the buffer 220. The buffer 220 may be configured to buffer data transmitted from corresponding one of the first and second hosts 20a and 20b and data to be received by the corresponding one of the first and second hosts 20a and 20b. The communication speed between the first LED 100a and the second LED 100b may be higher than the communication speed between the first host 20a and the first communication circuit 10a and the communication speed between the second host 20b and the second communication circuit 10b.

This configuration helps to allow the semiconductor device 1 to achieve full-duplex communication between the hosts 20 with higher reliability.

In accordance with one or more embodiments, the electronic apparatus 1000 may include the foregoing semiconductor device 1, the first host 20a, and the second host 20b.

This configuration makes it unnecessary to provide a light-emitting element and a light-receiving element separately from each other in each of the communication circuits 10a and 10b included in the semiconductor device 1 of the electronic apparatus 1000, and helps to, by the provision of the single LED 100 in each of the communication circuits 10a and 10b, allow the communication circuits 10a and 10b to transmit and receive optical signals to and from each other. That is, the electronic apparatus 1000 helps to enable bidirectional isolated communication in an IC package with a simple configuration and also enables full-duplex communication between the hosts 20, without necessitating a total of four photo devices, i.e., two sets of light-emitting elements and light-receiving elements.

One or more embodiments may have any of the following configurations.

### 1

A communication circuit configured to transmit and receive an optical signal to and from another device through an optical signal propagator, the communication circuit including:

a processor configured to control emission and reception of the optical signal;

a light-emitting diode having a cathode side coupled to a first terminal and an anode side coupled to a second terminal, the light-emitting diode being configured to emit and receive the optical signal;

a first switch provided between the first terminal and a ground, the first switch being configured to be controlled, through control from the processor, to be on or off when the light-emitting diode emits the optical signal, and to be off when the light-emitting diode receives the optical signal;

a second switch provided between the second terminal and a power supply, the second switch being configured to be controlled, through control from the processor, to be on when the light-emitting diode emits the optical signal, and to be off when the light-emitting diode receives the optical signal;

a third switch provided between the second terminal and the ground, the third switch being configured to be controlled, through control from the processor, to be off when the light-emitting diode emits the optical signal, and to be on when the light-emitting diode receives the optical signal; and

a fourth switch provided between the first terminal and the power supply, the fourth switch being configured to be controlled, through control from the processor, to be off when the light-emitting diode emits the optical signal, and to be on when the light-emitting diode receives the optical signal.

### 2

The communication circuit according to (1), further including an amplifier coupled to the second terminal, the amplifier being configured to amplify a voltage resulting from a dark current, of the light-emitting diode, that flows through the second terminal when the light-emitting diode receives the optical signal.

### 3

A semiconductor device including:

a first communication circuit coupled to a first host, the first communication circuit being the communication circuit according to (1) or (2);

a second communication circuit coupled to a second host, the second communication circuit being the communication circuit according to (1) or (2); and

the optical signal propagator, the optical signal propagator being provided between a first light-emitting diode and a second light-emitting diode, the first light-emitting diode being the light-emitting diode of the first communication circuit, the second light-emitting diode being the light-emitting diode of the second communication circuit.

### 4

The semiconductor device according to (3), in which

each of the first communication circuit and the second communication circuit further includes a buffer, the buffer being configured to buffer data transmitted from corresponding one of the first and second hosts and data to be received by the corresponding one of the first and second hosts, and

a communication speed between the first light-emitting diode and the second light-emitting diode is higher than a communication speed between the first host and the first communication circuit and a communication speed between the second host and the second communication circuit.

### 5

An electronic apparatus including:

the semiconductor device according to (4);

the first host; and

the second host.

A communication circuit, a semiconductor device, and an electronic apparatus according to one or more embodiments each may enable bidirectional isolated communication in an IC package with a simple configuration.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims.

The limitations in the claims are to be interpreted broadly based on the language employed in the claims and not limited to examples described in this specification or during the prosecution of the application, and the examples are to be construed as non-exclusive.

As used in this specification and the appended claims, the singular forms "a," "an," and "the" include, especially in the context of the claims, may be construed to cover both the singular and the plural, unless otherwise indicated herein or clearly contradicted by context.

Throughout this specification and the appended claims, unless the context requires otherwise, the terms "comprise", "include", "have", and their variations may be construed to cover the inclusion of a stated element, integer, or step but not the exclusion of any other non-stated element, integer, or step.

The use of the terms first, second, etc. does not denote any order or importance, but rather the terms first, second, etc. are used to distinguish one element from another.

The term "substantially", "approximately", "about", and its variants having the similar meaning thereto may be defined as being largely but not necessarily wholly what is specified as understood by one of ordinary skill in the art.

The term "disposed on/ provided on/ formed on" and its variants having the similar meaning thereto as used herein may refer to elements disposed directly in contact with each other or indirectly by having intervening structures therebetween.

1. A communication circuit that transmits and receives an optical signal to and from a device through an optical signal propagator, the communication circuit comprising:
a processor that controls emission and reception of the optical signal;
a light-emitting diode comprising a cathode side coupled to a first terminal, and an anode side coupled to a second terminal, the light-emitting diode emitting and receiving the optical signal;
a first switch arranged between the first terminal and a ground, the first switch being controlled, through control from the processor, to be on or off in response to the light-emitting diode emitting the optical signal, and to be off in response to the light-emitting diode receiving the optical signal;
a second switch arranged between the second terminal and a power supply, the second switch being controlled, through control from the processor, to be on in response to the light-emitting diode emitting the optical signal, and to be off in response to the light-emitting diode receiving the optical signal;
a third switch arranged between the second terminal and the ground, the third switch being controlled, through control from the processor, to be off in response to the light-emitting diode emitting the optical signal, and to be on in response to the light-emitting diode receiving the optical signal; and
a fourth switch arranged between the first terminal and the power supply, the fourth switch being controlled, through control from the processor, to be off in response to the light-emitting diode emitting the optical signal, and to be on in response to the light-emitting diode receiving the optical signal.

2. The communication circuit according to claim 1, further comprising an amplifier coupled to the second terminal, the amplifier amplifying a voltage resulting from a dark current, of the light-emitting diode, that flows through the second terminal in response to the light-emitting diode receiving the optical signal.

3. A semiconductor device comprising:
a first communication circuit coupled to a first host, the first communication circuit comprising the communication circuit according to claim 1;
a second communication circuit coupled to a second host, the second communication circuit comprising the communication circuit according to claim 1; and
the optical signal propagator, the optical signal propagator being arranged between a first light-emitting diode and a second light-emitting diode, the first light-emitting diode comprising the light-emitting diode of the first communication circuit, the second light-emitting diode comprising the light-emitting diode of the second communication circuit.

4. The semiconductor device according to claim 3, wherein
each of the first communication circuit and the second communication circuit further comprises a buffer, the buffer buffering data transmitted from corresponding one of the first and second hosts and data to be received by the corresponding one of the first and second hosts, and
a communication speed between the first light-emitting diode and the second light-emitting diode is higher than a communication speed between the first host and the first communication circuit and a communication speed between the second host and the second communication circuit.

5. An electronic apparatus comprising:
the semiconductor device according to claim 4;
the first host; and
the second host.
